(19) United States
(12) Patent Application Publication
(10) Pub. No.: US 2024/0151275 A1
(43) Pub. Date: May 9, 2024

(54) DRIVE SYSTEM

(71) Applicant: Physik Instrumente (PI) GmbH & Co. KG, Karlsruhe (DE)

(72) Inventors: Michael EBERT, Karlsruhe (DE); Christian RUDOLF, Karlsbad (DE); Christian SANDER, Karlsruhe (DE)

(73) Assignee: Physik Instrumente (PI) GmbH & Co. KG, Karlsruhe (DE)

(21) Appl. No.: 17/769,520

(22) PCT Filed: Oct. 19, 2020
(86) PCT No.: PCT/EP2020/079357

§ 371 Date: Apr. 15, 2022

(30) Foreign Application Priority Data
Oct. 18, 2019 (DE) 10 2019 216 106.5

(51) Int. Cl. F16D 3/64; F16C 3/18; F16C 3/28

(52) U.S. Cl. CPC F16D 3/64; F16C 3/18; F16C 3/28

(57) ABSTRACT

A drive system as disclosed includes an input shaft, an output shaft, and at least two coupling elements respectively coupled to the input shaft and the output shaft. In order to absorb assembly and manufacturing tolerances with respect to the shafts, the coupling elements and their attachment to the shafts and thereby prevent jamming of the drive system, at least one coupling element has an elastically deformable section, the elastically deformable section having a different material or a different cross-section than an adjacent section of the coupling element.

The present invention relates to a drive system according to the preamble of claim 1.

Due to installation space requirements and mounting reasons, as well as to reduce thermal influences, an energy converter (e.g. motor) may be arranged locally separated from an actuator axis. However, this requirement necessitates energy transmission from an input to an output side.

From the prior art there is known the transmission of torque from an input shaft to an output shaft arranged parallel thereto by means of coupling elements (e.g. connecting rods). In this respect, for example, the drive systems disclosed in DE 10 2007 035 309 A1, WO 2009/123551 A1 and U.S. Pat. No. 8,925,406 B1 provide for more than one coupling element between the input shaft and the output shaft.

Such drives, however, tend to jam due to assembly and manufacturing tolerances of the shafts as well as the coupling elements and their attachment to the shafts. Therefore, it is the object of the present invention to provide a drive system having an input shaft and an output shaft and at least two coupling elements connected therebetween, in which jamming is prevented.

To address this object, the present invention provides the drive system according to claim 1, comprising: an input shaft, an output shaft, at least two coupling elements respectively coupled to the input shaft and the output shaft, wherein at least one coupling element has an elastically deformable section, and the elastically deformable section has a different material or cross-section than an adjacent section of the coupling element.

Due to the elastically deformable section of the coupling element, there is a flexible distance between the two connecting sections of the coupling element through which the coupling element is connected to the shafts. Since at least one coupling element has the elastically deformable section, deviations in the alignment of the shaft axes and differences in the lengths of the coupling elements may be compensated for by elastic deformation of the elastically deformable section during operation. With this configuration, a backlash-free and precise transmission of the torque may nevertheless be ensured. Furthermore, the drive system according to the invention is also suitable for use in the low-temperature range (up to cryogenic temperatures) and in ultra-high vacuum. Due to a parallel-mounted motor, the drive system remains compact. Furthermore, the components of the drive system according to the invention compare favorably with gears or friction wheels, which must be precisely manufactured and require accurate adjustment of the shaft axes.

Preferred embodiments are the subject-matter of the dependent claims.

It may be advantageous if the elastically deformable section is configured in such a way that, due to elastic deformation of the elastically deformable section, at least part of the drive power is absorbed during operation and the efficiency of the drive system is in the range between 50 and 100%, preferably in the range between 90 and 95%, preferably in the range between 95 and 99%, and/or the torque variation between the input shaft and the output shaft is in the range between 0 and 50%, preferably in the range between 1 and 25%, preferably in the range between 1 and 10%. Drive systems according to the invention that have high efficiency and low torque variation preferably meet requirements for a continuously and comparatively fast rotating output shaft, whereas a drive system with comparatively low efficiency and high torque variation may be used in positioning systems, in which the output shaft usually performs only fractions of a revolution.

It may be useful if the elastically deformable section is located exactly or substantially centrally between the input shaft and the output shaft. Due to the symmetrical arrangement of the elastically deformable section, the elasticity or flexibility of the coupling element may act uniformly in both directions along the longitudinal extent of the coupling element.

It may be advantageous if the elastically deformable section includes an elastic element, preferably in the form of a spring or an elastomer. By appropriate selection of the elastic element the elasticity of the elastically deformable section may be selectively adjusted.

According to the invention, the elastically deformable section has a different material or a different cross-section than an adjacent section of the coupling element. As a result, the elastically deformable section may be integrated into the coupling element with a material bond and/or the entire coupling element may be formed in one piece.

It may be advantageous if both the input shaft and output shaft have one or more eccentric sections, and each coupling element is coupled to the corresponding eccentric section. A simple and reliable connection of the coupling element may be achieved via the eccentric section, by, for example, a connecting section at the end of the coupling element that receives the eccentric section.

It may also be beneficial if each coupling element is coupled to an end face of the input shaft and/or an end face of the output shaft. This may allow free access to the input shaft or output shaft along its axis of rotation.

It may be useful if the coupling elements are arranged on the input shaft and the output shaft such that they are preferably 60° or 90° out of phase with each other. This arrangement may provide a more constant or uniform torque transmission between the input shaft and the output shaft, while avoiding a singularity in the motion space.

It may prove useful if the input shaft and the output shaft are elastically mounted, preferably in a common housing, particularly preferably in an elastically deformable housing. This may further reduce the risk of jamming of the drive system.

It may be advantageous if the output shaft has a longitudinal slot extending along the axis of rotation. The longitudinal slot may accommodate an optical fiber.

It may be advantageous if the output shaft has a clamping device in the region of the longitudinal slot to clamp an optical fiber arranged in the longitudinal slot. This allows the optical fiber to be positioned and fixed on the axis of rotation of the output shaft.

It may be useful if one or both of the coupling elements is/are U-shaped. The specific motion space of the U-shaped coupling elements may result in a free space in the vicinity of the shafts that may be used, for example, for positioning the optical fiber.

It may be convenient if the output shaft is adjustable by a rotation angle of +/−135° about the rotation axis. This may provide a positioning system whose use case requires such a range of rotation angles.

Another aspect of the invention relates to a hexapod including a plurality of legs and at least one drive system according to any of the preceding embodiments, wherein the output shaft of one of the drive systems is connected to one of the legs of the hexapod for movement thereof by actuation of the drive system.

### Terms and Definitions

Elastically deformable section of coupling element.

The elastically deformable section of the coupling element has a higher elasticity and thus a lower Young's modulus than the other sections of the coupling element, at least in the longitudinal direction of the coupling element (direction perpendicular to the shaft axes).

### BRIEF DESCRIPTION OF THE DRAWINGS

FIG. 1 shows a schematic sectional view of a first embodiment of the drive system according to the invention.

FIG. 2 shows a perspective view of the first embodiment of the drive system.

FIG. 3 shows a longitudinal section of the first embodiment of the drive system.

FIG. 4 shows a perspective view of a second embodiment of the drive system according to the invention.

FIG. 5 shows a front view of the second embodiment of the drive system.

### DETAILED DESCRIPTION OF THE PREFERRED EMBODIMENTS

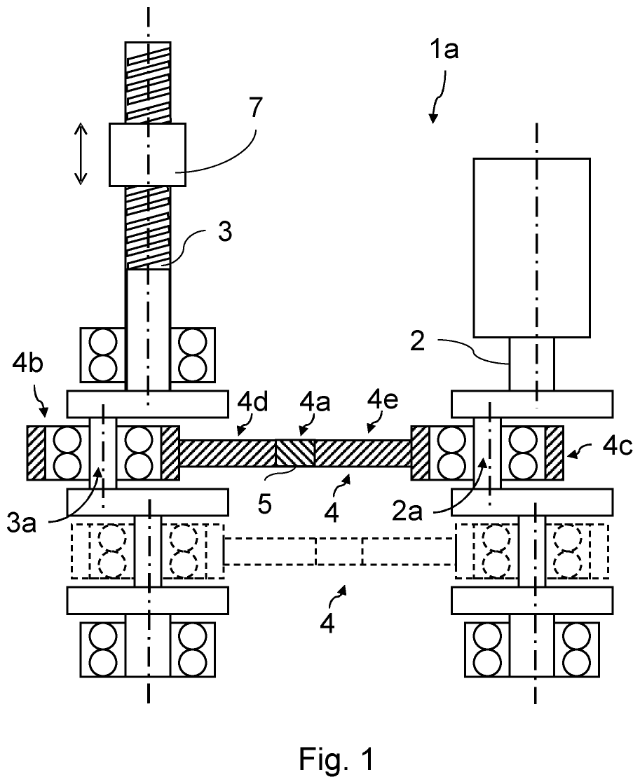

FIG. 1 schematically shows a first embodiment of the drive system. The drive system 1a includes a drive shaft 2 and an output shaft 3 arranged parallel thereto. Both shafts 2, 3 are mounted via rolling bearings. The bearing arrangement and the type of rolling bearing are not specified in more detail here. It goes without saying that various options exist for the bearing arrangement and the choice of rolling bearings to meet the requirements of specific applications. In addition to rolling bearings, the use of plain bearings is also possible.

Furthermore, the drive system 1a includes two coupling elements 4. The number of coupling elements is not limited to two. In particular, the drive system 1a may also include more than two coupling elements 4. In the present embodiment, each coupling element 4 is connected to an eccentric section 2a, 3a of the input and output shafts 2, 3 via a connecting section 4b, 4c. In this case, the connection is preferably made via rolling bearings, with an outer ring of the corresponding rolling bearing being connected to the connecting section 4b, 4c of the coupling element 4 and an inner ring being connected to the eccentric section 2a, 3a of the input or output shaft 2, 3. In addition to other types of connection, plain bearings may be used instead of rolling bearings. The eccentric sections 2a, 3a or the coupling elements 4 are preferably arranged 60° or 90° out of phase with one another with respect to the axes of rotation of the input or output shafts 2, 3.

According to the invention, at least one of the coupling elements 4 includes an elastically deformable section 4a. In a case where the drive system 1a includes more than two coupling elements 4, at least so many coupling elements 4 include the elastically deformable section 4a that the number of coupling elements 4 having the elastically deformable section 4a is one less than the total number of coupling elements 4. The elastically deformable section 4a is preferably arranged exactly or substantially centrally between the connecting sections 4b, 4c of each coupling element 4 or between the eccentric sections 2a, 3a of the input and output shafts 2, 3, respectively. Intermediate sections 4d, 4e of the coupling element 4 connect each connecting section 4b, 4c to the elastically deformable section 4a. The elastically deformable section 4a may be formed as an elastic element 5, for example in the form of an elastomer or a spring. The connecting sections 4b, 4c, the intermediate sections 4d, 4e and the elastic element 5 may be individual parts, each of which may have different materials and which are preferably joined by material bonding to form the coupling element 4. In addition, in one option the connecting sections 4b, 4c and the intermediate sections 4d, 4e may be formed in one piece and consequently also may be made of the same material. Furthermore, the entire coupling element 4 may also be of integral construction. In this case, the elastically deformable section 4a may be characterized by a smaller cross-section than the intermediate sections 4d, 4e or the connecting sections 4b, 4c of the coupling element 4.

In all embodiments of the coupling element 4, the elastically deformable section provides variable spacing of the connecting sections 4b, 4c, thereby compensating for differences in length of the coupling elements 4, deviations in the parallelism of the shaft axes, and generally assembly and manufacturing tolerances of the individual components of the drive system 1a, and preventing jamming of the drive system 1a. Consequently, part of the input power is absorbed by the elastically deformable section 4a due to elastic deformation, which affects the efficiency of the drive system 1a and results in torque variations between the input shaft 2 and the output shaft 3.

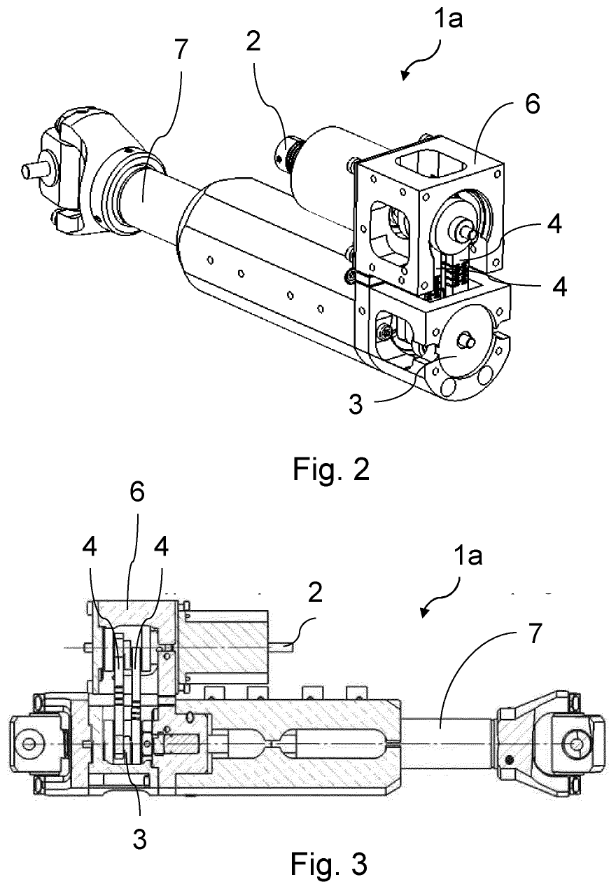

FIGS. 2 and 3 show respectively a perspective view and a longitudinal section of the first embodiment of the drive system 1a as part of a hexapod. In particular, the output shaft 3 is connected to an actuator 7 or leg of the hexapod, which is configured to perform a linear motion based on the rotation of the output shaft 3. Input and output shafts 2, 3 are mounted in a common housing 6, which is preferably also of elastic design. This enables elastic mounting of the shafts 2, 3, which introduces additional flexibility into the system and further reduces the risk of jamming.

In the present application, the drive system 1a is designed for continuous and rapid rotation of the output shaft 3. In order to reliably prevent jamming of the drive system 1a, the elastically deformable section 4a has a suitable absorption capacity, but preferably the efficiency of the drive system 1a is at least 95% and/or the torque variation between the input shaft 2 and the output shaft 3 is not greater than 20%.

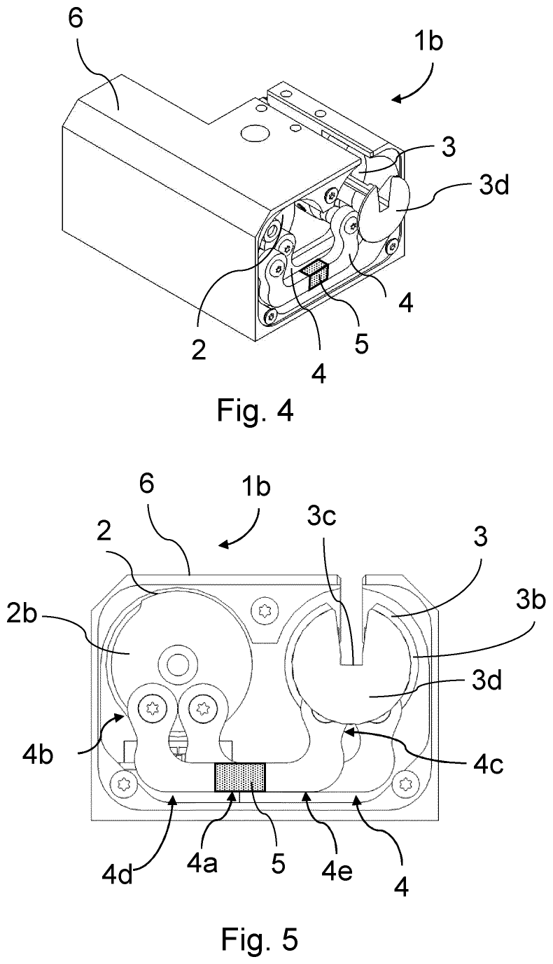

FIGS. 4 and 5 show a second embodiment of the drive system 1b according to the invention. The main difference from the first embodiment is that the connecting sections 4b, 4c of the coupling elements 4 are connected to end faces 2b, 3b of the input and output shafts 2, 3, the two coupling elements 4 being at different distances from the respective end faces 2b, 3b. In particular, the coupling elements 4 are rotatably attached to the end faces 2b, 3b of the shafts 2, 3 such that one coupling element 4 is located above the other coupling element 4, with respect to a direction perpendicular to the end faces 2b, 3b of the shafts 2, 3. A phase offset of the coupling elements 4 may also be realized in the present embodiment and is preferably 60°.

The various embodiments of the elastically deformable section 4a as an elastic element 5 made of a specific material or a specific shape or as a section with a reduced cross-section are already described with reference to the first embodiment of the drive system 1a.

Furthermore, for receiving an optical fiber, the output shaft 3 is provided with a receiving section 3d, which protrudes from the end face 3b and projects beyond the coupling elements 4 with respect to a direction perpendicular to the end face 3b. In the present embodiment, the coupling elements 4 are formed in a U-shape to allow rotation of the output shaft 3 in both directions up to a rotation angle, at which a coupling element 4 is blocked by the receiving section 3d. In particular, in the present embodiment, the rotation of the output shaft 3 is limited to a rotation angle of +/−135° about the rotation axis. The attachment of the coupling elements 4 to the end faces 2b, 3b of the input and output shafts 2, 3 ensures free access to the input and output shafts 2, 3, respectively, along their axis of rotation.

A longitudinal slot 3c is also formed in the output shaft 3 to receive the optical fiber, extending axially into the receiving section 3d and extending radially to the axis of rotation of the output shaft 3. The optical fiber may be clamped onto the rotational axis of the output shaft 3 by a clamping device provided in the longitudinal slot 3c of the output shaft 3 and/or the receiving section 3d.

The second embodiment of the drive system 1b is particularly suitable as a positioning system for an optical fiber, whose polarization angle may be precisely adjusted for coupling light by rotating the fiber about its rotation axis. In order to prevent jamming of the drive system 1b, the elastically deformable section 4a of the drive system 1b also has a suitable absorbing capacity, wherein the efficiency of the drive system 1b is at least 50% and/or the torque variation between the input shaft 2 and the output shaft 3 is not greater than 50%.

### LIST OF REFERENCE SIGNS

1a, 1b drive system
2 input shaft
2a eccentric section of the input shaft
2b end face of input shaft
3 output shaft
3a eccentric section of output shaft
3b end face of output shaft
3c longitudinal slot of output shaft
3d receiving section of output shaft
4 coupling element
4a elastically deformable section
4b, 4c coupling section
4d, 4e intermediate section
5 elastic element
6 housing
7 adjusting element

1-13. (canceled)

14. Drive system comprising:
an input shaft;
an output shaft;
at least two coupling elements coupled to the input shaft and the output shaft, respectively, wherein:
at least one coupling element of the at least two coupling elements has an elastically deformable section, the elastically deformable section having a different material or cross-section than an adjacent section of the coupling element, wherein the elastically deformable section is integrated into the coupling element by material bond and/or an entirety of the coupling element is formed as one piece.

15. Drive system according to claim 14, wherein the elastically deformable section is configured such that an elastic deformation of the elastically deformable section during operation will absorb at least part of a drive power of the drive system, and wherein an efficiency of the drive system is in a range between 50 and 100%, and/or a torque fluctuation between the input shaft and the output shaft is in a range between 0 and 50%.

16. Drive system according to claim 14, wherein the elastically deformable section is arranged exactly or substantially centrally between the input shaft and the output shaft.

17. Drive system according to claim 14, wherein the elastically deformable section has an elastic element, formed as a spring or an elastomer.

18. Drive system according to claim 14, wherein each of the input shaft and the output shaft comprises:
one or more eccentric sections, and each coupling element is coupled to a corresponding eccentric section.

19. Drive system according to claim 14, wherein each coupling element is coupled to an end face of the input shaft and/or an end face of the output shaft.

20. Drive system according to claim 1, wherein the coupling elements are arranged on the input shaft and the output shaft so as to be out of phase with one another.

21. Drive system according to claim 14, wherein the input shaft and the output shaft are mounted elastically, in a common housing.

22. Drive system according to claim 14, wherein the output shaft has a longitudinal slot extending along an axis of output shaft rotation.

23. Drive system according to claim 22, wherein the output shaft has a clamping device in a region of the longitudinal slot for clamping an optical fiber arranged in the longitudinal slot.

24. Drive system according to claim 14, wherein the at least one coupling element is U-shaped.

25. Drive system according to claim 22, wherein the output shaft is adjustable by a rotation angle of +/−135° about the axis of output shaft rotation.

26. Hexapod comprising:
a plurality of legs; and
at least one drive system according to claim 14, wherein the output shaft of the at least one drive system is connected to one of the legs of the hexapod in order to move the one leg by actuating the drive system.

27. Drive system according to claim 14, wherein the coupling elements are arranged on the input shaft and the output shaft so as to be out of phase with one another by 60° or 90°.

28. Drive system according to claim 14, wherein the input shaft and the output shaft are mounted elastically, in an elastically deformable housing.

29. Drive system according to claim 15, wherein the elastically deformable section is arranged exactly or substantially centrally between the input shaft and the output shaft.

30. Drive system according to claim 29, wherein the elastically deformable section has an elastic element, formed as a spring or an elastomer.

31. Drive system according to claim 30, wherein each of the input shaft and output shaft comprises:
one or more eccentric sections, and each coupling element is coupled to a corresponding eccentric section.

32. Drive system according to claim 31, wherein each coupling element is coupled to an end face of the input shaft and/or an end face of the output shaft.

33. Hexapod comprising:
a plurality of legs; and
at least one drive system according to claim 32, wherein the output shaft of the at least one drive system is connected to one of the legs of the hexapod in order to move at least the one leg by actuating the drive system.
